(19) United States
(12) Patent Application Publication
(10) Pub. No.: US 2016/0378762 A1
(43) Pub. Date: Dec. 29, 2016

(54) METHODS AND SYSTEMS FOR IDENTIFYING MEDIA ASSETS

(71) Applicant: Rovi Guides, Inc., Santa Clara, CA (US)

(72) Inventor: Alon Rohter, San Francisco, CA (US)

(21) Appl. No.: 14/753,371

(22) Filed: Jun. 29, 2015

(51) Int. Cl. G06F 17/30; H04N 21/431; H04N 21/234; H04N 21/44; H04N 21/2665; H04N 21/462

(52) U.S. Cl. CPC G06F 17/3053; H04N 21/2665; H04N 21/4622; H04N 21/23418; H04N 21/44008; H04N 21/431; G06F 17/30598; G06F 17/30867

(57) ABSTRACT

Methods and systems are disclosed for a media guidance application that improves the collection and/or validation of data received from multiple sources. For example, the media guidance application may determine how similar received data is to data known to correspond to a particular media asset to determine whether or not the received data corresponds to the particular media asset. Moreover, the media guidance application may normalize the data into a consistent format prior to the determination. By normalizing the data into a consistent format, the media guidance application reduces false negatives when determining whether or not data corresponds to a particular media asset.

### BACKGROUND

In conventional systems, users typically have access to a plethora of media content from numerous sources. With so much media content available, users often need assistance in searching for, navigating to, and selecting a particular media asset to consume. For example, with so much media content available, users are often unaware of what sources are available and what media content is available from each source.

In many cases, users may search available media content based on data (e.g., metadata) associated with each particular media asset. For example, data associated with each particular media asset may be captured and used to populate in a searchable database. However, as media content may be received from numerous sources, the data describing that media content may lack consistent formatting, structure, etc. Due to these inconsistencies, the data, which would otherwise be used to identify a media asset, populate the searchable database, verify the veracity of data currently included in the database, and/or expand the ways in which the database may be searched is either ignored or unusable.

### SUMMARY

Accordingly, methods and systems are disclosed herein for a media guidance application that improves the collection and/or validation of data received from multiple sources in order to identify media assets. For example, the media guidance application may determine how similar data related to an unknown media asset is to data known to correspond to an identified media asset to determine whether or not the received data corresponds to the identified media asset. Moreover, the media guidance application may normalize the data into a consistent format prior to the determination. For example, before comparing the data received from different sources, the media guidance application may ensure that corresponding types of data (e.g., data indicating the title of a media asset) are in the same format. Once the data has been properly normalized, the media guidance application may compare the data from multiple sources. By normalizing the data into a consistent format, the media guidance application reduces false negatives when determining whether or not data corresponds to a particular media asset.

Furthermore, the media guidance application may compute scores for the received data that indicate a level of similarity between the received data and data from an identified media asset both on a categorical and composite level. For example, the media guidance application may compute scores for individual categories of received data as well as the data as a whole. Additionally, the media guidance application may weigh the data based on its source, reliability, and/or importance. For example, the media guidance application may consider data received from an established provider of media guidance data as more reliable than data received from a new provider of media guidance data. Likewise, the media guidance application may consider certain categories of data (e.g., title) to be more important to validating data than other categories of data (e.g., broadcast date). Based on the computed score, the media guidance application may determine whether or not to validate the received data as corresponding to a particular media asset and/or aggregate the received data with data known to correspond to an identified source.

Finally, the media guidance application may use both automatic and semi-automatic techniques to validate the data. For example, in addition to applying the algorithms discussed above to compute scores related to the data, the media guidance application may compare the scores to certain threshold values. Based on the comparison, the media guidance application may prompt users for manual reviews of data. Through the use of both automatic and semi-automatic techniques the media guidance application improves the precision at which data is validated. Once the data is validated, the media guidance application may use the data to populate an ever-expanding database of identified media assets.

In some aspects, the media guidance application may extract first data describing a media asset from a first source, in which the data is organized into a plurality of fields. For example, each field of the plurality of fields may correspond to a particular category of media guidance data (e.g., title, genre, release date, etc.).

The media guidance application may then identify a first category of a first field of the plurality of fields. For example, the media guidance application may process data corresponding to the first field according to the identified category. For example, the media guidance application may determine a first data type (e.g., an alphanumeric dating system) of the first field. The media guidance application may then cross-reference the first data type with a database listing categories that correspond to various data types to determine the first category. For example, in response to determining that an alphanumeric dating system found in the first field typically indicates a release date, the media guidance application may determine that the first field corresponds to a release date of the media asset.

The media guidance application may then determine a first field score corresponding to the first field based on the first category. For example, the media guidance application may compare the release date for the media asset as indicated by the first field (e.g., a first datum) to a known release date for the media asset (e.g., a second datum from a second source) to determine a level of similarity between the two release dates. Based on the level of similarity, the media guidance application may assign a score to the first field. For example, if the release dates are identical the score is likely higher than if the release dates are different. Additionally, the media guidance application may determine a boost metric (e.g., indicating an importance or reliability of the first category) associated with the first category, which the media guidance application may cross-reference with a database listing weights associated with various boost metrics to determine a weight to apply to the first field when computing a composite score. For example, the media guidance application may apply a higher boost metric to one category (e.g., title), which typically has a higher level of similarity, than another category (e.g., summary information), which typically has a lower level of similarity.

The media guidance application may compare the first field score to a threshold field score. For example, the media guidance application may determine whether or not the first field score is sufficient enough for use based on a comparison to the threshold field score. If so, the media guidance application may select the first field for use in computing a composite score. For example, the composite score may indicate a level of similarity between the first data and second data, in which the second data is from a second source and corresponds to data known about the media asset. If not, the media guidance application may prompt a user to manually review the first field score.

The media guidance application may then determine whether or not the composite score equals or exceeds a threshold composite score. If so, the media guidance application may generate for display, on a display device, a user-selectable option to assign an identifier to the media asset. For example, in response to determining that the first data has a threshold level of similarity with data known to correspond to a particular media asset, the media guidance application may prompt a user to verify that the first data corresponds to the particular media asset. Additionally, the media guidance application may prompt a user to determine whether to aggregate the first data and the second data in a database. For example, in response to determining that the first data corresponds to a particular media asset, the media guidance application may incorporate the first data into a database listing known data about the media asset.

In some embodiments, the composite score may include respective field scores for each field of a plurality of fields. For example, the media guidance application may identify categories and field scores based on the identified categories for one or more fields of the plurality of fields in the first data. For example, the media guidance application may compare each field (e.g., corresponding to a particular category) of the data set to a field (e.g., corresponding to the same category) of the data known to correspond to a particular media asset to determine how similar received data is to data known to correspond to a particular media asset. Moreover, the order in which each field is compared may depend on the fields that were already compared. For example, the media guidance application may increase the efficiency of the comparison process by dynamically selecting which categories to compare (e.g., the media guidance application may compare more important and/or reliable categories before less important and/or reliable categories).

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 is an illustrative diagram of a media guidance application collecting data about media assets for user review from a plurality of sources in accordance with some embodiments of the disclosure;

FIG. 2 is a block diagram of an illustrative system for compiling media guidance data in accordance with some embodiments of the disclosure;

FIG. 3 is a block diagram of an illustrative system upon which a media guidance application may be implemented in accordance with some embodiments of the disclosure;

FIG. 4 is an illustrative diagram of a system for comparing media guidance data from multiple sources to a database of known media guidance data in accordance with some embodiments of the disclosure;

FIG. 5 is a flowchart of illustrative steps involved in generating for display, on a display device, a user-selectable option to assign an identifier to the media asset in accordance with some embodiments of the disclosure; and

FIG. 6 is a flowchart of illustrative steps involved in updating a source of media guidance data in accordance with some embodiments of the disclosure.

### DETAILED DESCRIPTION OF THE DRAWINGS

Methods and systems are disclosed herein for a media guidance application that improves the collection and/or validation of data received from multiple sources. For example, the media guidance application may determine how similar received data is to data known to correspond to a particular media asset to determine whether or not the received data corresponds to the particular media asset.

As referred to herein, “a media guidance application” is any application that facilitates the collection and organization of media guidance data. Media guidance applications may take various forms depending on the content for which they provide guidance. The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. Another type of media guidance application allows users to review and compare media guidance data from multiple sources through an interface. For example, the media guidance application may receive media guidance data from one or more sources and compare that to media guidance data located at a different source.

As referred to herein, the phrase “media guidance data” or “guidance data” should be understood to mean any data related to a media asset or data that may be used to distinguish one media asset from another. For example, the media guidance data may include but is not limited to, broadcast times, broadcast channels, titles, descriptions, ratings information (e.g., parental control ratings, critic's ratings, etc.), genre or category information, actor information, broadcasters' or providers' information, media format (e.g., standard definition, high definition, 3D, etc.), advertisement information (e.g., text, images, media clips, etc.), on-demand information, blogs, websites, and any other type of data (e.g., metadata) that relates to a media asset, a user that consumes the media asset, and/or a provider or source of the media asset.

As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application may normalize the data from various sources (e.g., prior to comparing the data). As referred to herein, normalizing acquired data may relate to any process in which received data is adjusted, arranged, or otherwise processed in order to prepare the data for use by the media guidance application. In some embodiments, the media guidance application may normalize received data by mapping the various fields of the received data to known fields. For example, the media guidance application may map a field of the received data corresponding to a particular category to a known field associated with that particular category. For example, if the media guidance application determines that a first field corresponds to a title of a media asset, the media guidance application may map that field to a field that is known to correspond to the title of a media asset. Due to this, the media guidance application ensures that when determining whether or not first data (e.g., received from a first source) corresponds to second data (e.g., received from a second source, in which the second data is known to correspond to a particular media asset) the field of the first data that corresponds to the title is compared to the field of the known data that corresponds to the title. By normalizing the data in this way, the media guidance application prevents false negative results based on improperly mapped field comparisons (e.g., comparing a field associated with a title to a field associated with a genre).

Additionally or alternatively, the media guidance application may normalize received data by converting data in the various fields of the received data to the same format as data in known fields. For example, the media guidance application may convert data in a field of the received data corresponding to a particular category to the same format as that of data in a known field associated with that particular category. For example, if the media guidance application determines that the data in the first field corresponds to a particular language (e.g., human, computer, etc.), the media guidance application may convert the data in that field to a language used in a corresponding field of known data. Due to this, the media guidance application ensures that when determining whether or not first data (e.g., received from a first source) corresponds to second data (e.g., received from a second source, in which the second data is known to correspond to a particular media asset) the first data and the second data are compared in the same language. By normalizing the data in this way, the media guidance application prevents false negative results based on non-standardized languages (e.g., comparing a title in English to a title in Mandarin).

In another example, if the media guidance application determines that the data in the first field corresponds to a particular standardization (e.g., a release date indicated in a month, day, year format), the media guidance application may convert the data in that field to a standardization used in a corresponding field of known data (e.g., a release date indicated in a day, month, year format). Due to this, the media guidance application ensures that when determining whether or not first data (e.g., received from a first source) corresponds to second data (e.g., received from a second source, in which the second data is known to correspond to a particular media asset), the first data and the second data are compared in the same standardization. By normalizing the data in this way, the media guidance application prevents false negative results based on non-standardized languages (e.g., comparing a month designation to a day designation).

Additionally or alternatively, the media guidance application may normalize received data by adopting industry nomenclatures, industry standards, ranges, and/or allowable variances. For example, the media guidance application may determine that although data in a field of the received data is not identical to data in a corresponding field of known data, the data is within an allowable range. For example, when comparing the title of a program the media guidance application may ignore minor spelling and/or grammatical differences in the titles. For example, the media guidance application may apply fuzzy logic in order to determine that two titles are the same although the titles are spelled differently. In another example, the media guidance application may determine that although data in a field of the received data is not identical to data in a corresponding field of known data, the received data corresponds to nomenclature the context of which corresponds to the context of the data in the known field. For example, the media guidance application may determine that a field associated with a “broadcast date” corresponds, in some cases, to a field associated with “release date.” By normalizing the data in this way, the media guidance application may compare additional types of data that would under normal circumstances be discarded.

Additionally or alternatively, the media guidance application may normalize received data by submitting received data for manual or semi-manual user inspection. For example, the media guidance application may determine that a particular format of received data is unrecognizable. In such cases, instead of discarding the data, the media guidance application may prompt a user to provide a proper formatting. In such cases, the media guidance application may offer suggested formats or categories.

By normalizing the data into a consistent format in one or more of the ways discussed above, the media guidance application reduces false negatives when determining whether or not data corresponds to a particular media asset as well as expands the amount and/or types of data that may be used to determine whether or not data from multiple sources corresponds to the same media asset.

After normalizing the data, the media guidance application may compute scores for the received data that indicates a level of similarity between the received data and data from a previously validated source both on a categorical and composite level. As referred to herein, “a level of similarity” may be a quantitative or qualitative assessment of the degree to which data corresponds. For example, the level of similarity may represent a given percentage, ratio, or other value that indicates the likelihood that data refers to the same media asset, media guidance data, etc. In another example, the media guidance application may indicate a level of confidence that the media guidance application (or a user) has data that refers to the same media asset, media guidance data, etc. The level of similarity may be based on an absolute measurement or may be relative to other comparisons.

The media guidance application may determine a field score associated with a field. As referred to herein, “a field score” is a quantitative or qualitative assessment of the level of similarity between data in corresponding fields. For example, the media guidance application may determine a first field score corresponding to the first field based on the first category by determining a first datum of the first data corresponding to the first field (e.g., a title indicated by the first data). The media guidance application may then determine a second field of the second data that corresponds to the first category (e.g., a title indicated by the second data). The media guidance application may determine a second datum of the second field and compare the first datum to the second datum to determine the first field score corresponding to the first field.

Furthermore, the media guidance application may adjust a score and/or level of similarity based on factor other than the similarity (or lack thereof) of the data. For example, the media guidance application may apply a boost metric to a computed score. As referred to herein, a “boost metric” is any factor, other than the similarity between data being compared that affects a computed score and/or a determined level of similarity. For example, in some cases, the media guidance application may determine that a score should be increased (or weighted) due to a particular factor associated with the data such as its source, reliability, and/or importance. For example, the media guidance application may consider data received from an established provider of media guidance data as more reliable than data received from a new provider of media guidance data. Accordingly, the media guidance application may apply a boost metric to data based on the source.

Likewise, the media guidance application may consider certain categories of data (e.g., title) to be more important to validating data than other categories of data (e.g., broadcast date). For example, the title of a media asset may be more likely to be standardized across various media guidance data providers than the broadcast date. Accordingly, the media guidance application may apply a boost metric to data based on this reliability.

Likewise, the media guidance application may consider the variance and amount of corresponding data in certain categories of data when computing a score. For example, if a particular category of data has little variance (e.g., media guidance data received from multiple sources all corresponds), the media guidance application may increase the effect of data corresponding (or not corresponding) in that category. Likewise, if a particular number of media guidance data sources provide the same corresponding media guidance data, the media guidance application may increase the effect of data corresponding (or not corresponding) in that category.

The media guidance application may compare the first field score to a threshold field score. As referred to herein, a “threshold score” is a quantitative or qualitative measurement of a field score that triggers a particular action. For example, the media guidance application may determine whether or not a field score is sufficient enough for use based on a comparison to the threshold field score. For example, if a field score equals or exceeds a threshold field score, the media may select the corresponding field for use in computing a composite score. Alternatively, if a field score does not equal a threshold field score, the media guidance application may prompt a user to manually review the first field score, may disregard the field score, and/or re-compute the field score.

The threshold score may be based on data received from the user, industry standards, or a third party. Furthermore, the threshold score may be relative to a particular category or constant throughout the categories. For example, in some embodiments, the threshold score associated with a title field may be higher than a threshold score associated with a genre field. In contrast, in some embodiments, the threshold score for the title field and genre field may be equal.

As referred to herein, a “composite score” is a qualitative or quantitative assessment of whether or not data corresponds to a particular media asset. For example, the media guidance application may determine a composite score corresponding to first data based on an average (or by applying another suitable mathematical computation or algorithm) of one or more field scores. The media guidance application may then retrieve and compare the composite score to a threshold composite score.

As referred to herein, a “threshold composite score” is a quantitative or qualitative measurement of a field score that triggers a particular action. For example, the media guidance application may determine whether or not a composite score is sufficient enough for use based on a comparison to the threshold composite score. For example, if a composite score equals or exceeds a threshold composite score, the media guidance application may determine that data corresponds to a particular media asset. Alternatively, if a composite score does not equal a threshold field score, the media guidance application may prompt a user to manually review the composite score, may disregard the composite score, re-compute the composite score, compare the data used to generate the composite score to data known to be associated with a different media asset, and/or determine that the media asset associated with the data used to generate the composite score was a previously unknown media asset.

The media guidance application may extract first data describing a media asset from a first source, in which the data is organized into a plurality of fields. For example, each field of the plurality of fields may correspond to a particular category of media guidance data (e.g., title, genre, release date, etc.). It should be noted that the media guidance application may extract and/or interpret media guidance data received in a plurality of forms. For example, the media guidance application may normalize the data (e.g., as discussed above). Furthermore, the media guidance application is not limited to the source from which it can extract media guidance data.

As referred to herein, a “source” refers to any entity, person, device, media asset, or other medium from which media guidance data may be obtained. For example, the media guidance application may obtain media guidance data stored in a device. As referred to herein, the phrase “device” should be understood to mean any medium through which media guidance data may be accessed or stored such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices.

Additionally or alternatively, the media guidance applications may obtain media guidance data through the user of online applications (i.e., provided on a website), or as stand-alone applications or clients on user equipment devices. For example, the media guidance application may ping or query a web server for information related to media assets. For example, the media guidance application may search industry or third-party databases associated with media guidance data as well as user-generated content such as content available via a social network.

As used herein, a “social network,” refers to a platform that facilitates networking and/or social relations among people who, for example, share interests, activities, backgrounds, and/or real-life connections. In some cases, social networks may facilitate communication between multiple user devices (e.g., computers, televisions, smartphones, tablets, etc.) associated with different users by exchanging content from one device to another via a social media server. As used herein, a “social media server” refers to a computer server that facilitates a social network. For example, a social media server owned/operated/used by a social media provider may make content (e.g., status updates, microblog posts, images, graphic messages, etc.) associated with a first user accessible to a second user that is within the same social network as the first user. In such cases, classes of entities may correspond to the level of access and/or the amount or type of content associated with a first user that is accessible to a second user.

The media guidance application may use various techniques for identifying and extracting media guidance data. For example, in addition to polling and receiving data from devices and networks that have collections of media guidance data, the media guidance application may create and store media guidance data. For example, the media guidance application may use a content recognition module or algorithm to generate data describing the context, content, and/or any other data about a media asset. For example, the content recognition module may use object recognition techniques such as edge detection, pattern recognition, including, but not limited to, self-learning systems (e.g., neural networks), optical character recognition, online character recognition (including but not limited to, dynamic character recognition, real-time character recognition, intelligent character recognition), and/or any other suitable technique to determine objects (e.g., characters appearing on-screen, text describing a media asset, etc.) in a portion of the video content.

For example, the media guidance application may receive data in the form of a video. The video may include a series of frames. For each frame of the video, the media guidance application may use a content recognition module or algorithm to determine the objects (e.g., people, words, places, things, etc.) in each of the frames or series of frames. The media guidance application may cross-reference the determined objects with a database that lists media guidance data associated with the objects to generate media guidance data about the media asset.

In some embodiments, the content recognition module or algorithm may also include speech recognition techniques, including, but not limited to, Hidden Markov Models, dynamic time warping, and/or neural networks (as described above) to translate spoken words into text and/or processing audio data. For example, the media guidance application may cross-reference an identified spoken word with a database that lists media guidance data associated with the spoken words to generate media guidance data about the media asset.

The media guidance application may identify a first category of a first field of the plurality of fields. As referred to herein, a “category” is a group or type of data that is distinguishable from other groups or types of data. The media guidance application may process data corresponding to the first field according to the identified category. For example, the media guidance application may determine a first data type (e.g., an alphanumeric dating system) of the first field. The media guidance application may then cross-reference the first data type with a database listing categories that correspond to various data types to determine the first category. For example, in response to determining that an alphanumeric dating system found in the first field typically indicates a release date, the media guidance application may determine that the first field corresponds to a release date of the media asset. In another example, the media guidance application may determine a first data type (e.g., a series of alphanumeric characters) of the first field. In response to determining that the series of alphanumeric characters corresponds to an industry standard that identifies a title, the media guidance application may determine that the first field corresponds to a title of the media asset.

In some embodiments, the composite score may include respective field scores for each field of a plurality of fields. For example, the media guidance application may identify categories and field scores based on the identified categories for one or more fields of the plurality of fields in the first data. For example, the media guidance application may compare each field (e.g., corresponding to a particular category) of the data set to a field (e.g., corresponding to the same category) of the data known to correspond to a particular media asset to determine how similar received data is to data known to correspond to a particular media asset. Moreover, the order in which each field is compared may depend on the fields that were already compared. For example, the media guidance application may increase the efficiency of the comparison process by dynamically selecting which categories to compare (e.g., the media guidance application may compare more important and/or reliable categories before less important and/or reliable categories).

For example, the media guidance application may first compare fields associated with the most important category (e.g., a title field), which may correspond to the most heavily weighted score. If the field score of the title field exceeds the threshold score, the media guidance application may determine that the data is likely to correspond to a particular media asset. Accordingly, the media guidance application may compare unimportant categories or fields associated with unknown categories. The media guidance application may do this in order to determine new data about the identified media asset. For example, if the release date field for the media asset was previously unpopulated, and the received data has data corresponding to that field, the media guidance application may try to obtain data about the media asset in that field. For example, after identifying the media asset for which received data corresponds, the priority of the media guidance application may be to expand the data known about the media asset. In contrast, if the field score of the title field does not exceed the threshold score, the media guidance application may compare important categories or fields in order to identify the media asset to which the received data corresponds.

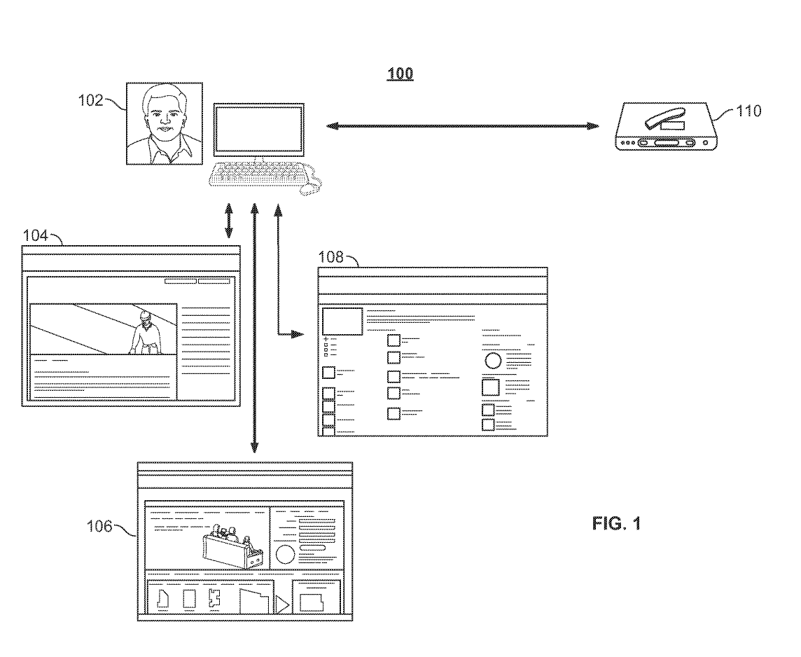

FIG. 1 shows an illustrative diagram of a media guidance application collecting data about media assets for user review from a plurality of sources. In system 100, user interface 102 receives data (e.g., metadata) about numerous media assets from the multiple sources (e.g., website services 104, 106, 108, and user device 110). A media guidance application implemented on user interface 102 may process the data received from the multiple sources to identify the media assets associated with that data. For example, the media guidance application may compare the data received from the multiple sources to data that is known to correspond to a particular media asset. If received data corresponds to data known to correspond to a particular media asset, the media guidance application may determine that the received data also corresponds to the particular media asset.

The website services 104, 106, and 108 shown in FIG. 1 may be implemented on any suitable user equipment device or platform (e.g., webpages accessed by a computer) and each represents a source. User device 110 may represent any type of user equipment device or platform, and also represents a source. For example, user device 110 may represent a provider of media guidance data that is also associated with providing media assets and/or a provider of media guidance data that is not associated with providing media assets. Likewise, each of website services 104, 106, and 108 may represent a provider of media guidance data that is also associated with providing media assets and/or a provider of media guidance data that is not associated with providing media assets. Each of website services 104, 106, and 108 may also represent a website account linked to a particular device, which may or may not be linked to a specific user, service, and/or source.

In system 100, website services 104, 106, 108 and user device 110 all supply media guidance data to user interface 102. User interface 102 may be located remotely from website services 104, 106, 108, and user device 110. In some embodiments, user interface 102 may access or be incorporated into a storage device (e.g., a server), which itself acts as a source of media guidance data. For example, user interface 102 may directly or indirectly access a core dataset, which is an aggregation of media guidance data received from website services 104, 106, 108, and user device 110. For example, a media guidance application may be implemented on user interface 102 and act to receive, normalize, compare, and validate data from website services 104, 106, 108, and user device 110.

In addition to collecting data related to linear programming (e.g., media guidance data about content that is scheduled to be transmitted to a plurality of user equipment devices at a predetermined time and is provided according to a schedule), the media guidance application may also collect data related to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet website or other Internet access (e.g. FTP).

In some embodiments, website services 104, 106, 108, and user device 110 may provide organization and access to non-linear programming including on-demand listings, recorded content listings, and Internet content listings. A display combining organization and access to content from different types of content sources is sometimes referred to as a “mixed-media” display. Various permutations of the types of organization to media content may be displayed and may be based on user selection or input (e.g., a display of only recorded and broadcast listings, only on-demand and broadcast listings, etc.). Through website services 104, 106, 108, and user device 110 a user may have access to media content that may be displayed in response to the user selecting one of the navigational icons, all of which may be monitored by the source. For example, pressing an arrow key on a user input device may affect the website services 104, 106, 108, and user device 110 in a similar manner as selecting navigational icons.

Website services 104, 106, 108, and user device 110 may also provide an advertisement for content that, depending on a viewer's access rights (e.g., for subscription programming), is currently available for viewing, will be available for viewing in the future, or may never become available for viewing, and may correspond to or be unrelated to one or more of the content listings shown in website services 104, 106, 108, and user device 110. Advertisements may also be for products or services related or unrelated to the content displayed in website services 104, 106, 108, and user device 110. Advertisements may be selectable and provide further information about content; provide information about a product or a service, enable purchasing of content; a product, or a service; provide content relating to the advertisement, etc., which may be monitored by the source.

Media guidance data may also include information related to media content advertisements as well as what content was watched, not watched, advertised but not watched, watched but not advertised, episodes in a series that were watched, or episodes in a series that were not watched. In the case of PPV or on-demand media content, the source may monitor content that was purchased individually, content that was not purchased individually, content that was purchased with particular other media content, content that was not purchased with particular other media content, or any other feasible method or combination of multiple methods. Furthermore, the source may provide this information as media guidance data to the media guidance application implemented on user interface 102.

The website services 104, 106, 108, and user device 110 may each include a personalized media guidance application that personalizes content, settings, or formatting based on a user's preferences, which may be monitored by the source. A personalized media guidance application allows a user to customize displays and features to create a personalized “experience” with the media guidance application. Users may access their personalized guidance application by logging in or otherwise identifying themselves to the guidance application. Customization of the media guidance application may be made in accordance with media content interests. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations, any of which may be monitored by the source and provided to the media guidance application implemented on user interface 102.

The media guidance application on a source may allow the source to automatically compile information on a user's media content interests. The media guidance application may, for example, monitor the content the user accesses and/or other interactions the user may have with the guidance application. Additionally, the media guidance application implemented on user interface 102 may obtain media guidance data from other websites on the Internet, such as www.allrovi.com, from other media guidance applications (e.g., implemented on other devices and/or sources), from other interactive applications the user accesses, from another user equipment device of the user, etc.), and/or obtain information about the user and/or media guidance data from other sources that the media guidance application may access.

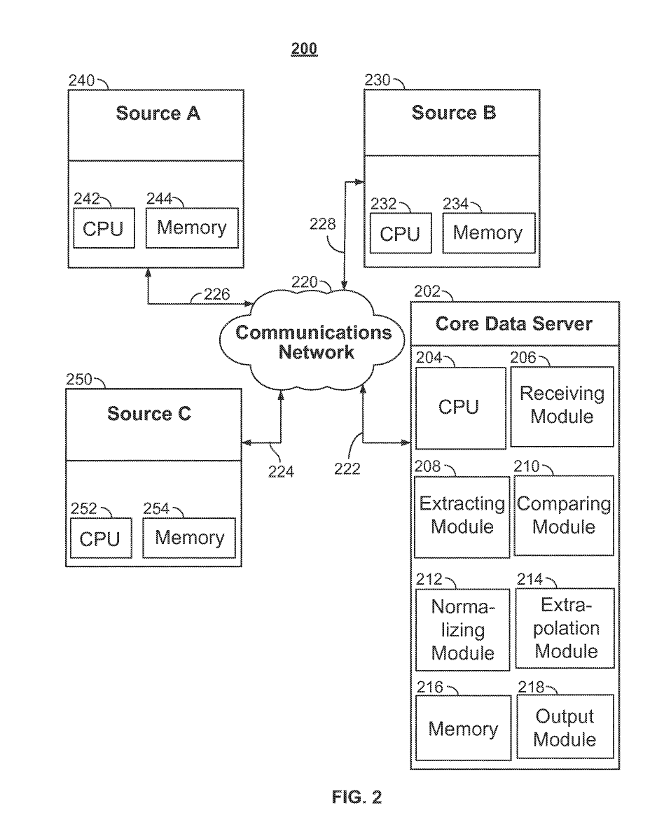

FIG. 2 is a block diagram of an illustrative system for compiling media guidance data. FIG. 2 shows core data server 202, source A 240, source B 230, source C 250, connected via communications network 220. For simplicity, source A 240, source B 230, and source C 250 may be referred to herein collectively as source equipment. Media guidance data for one or more media assets may be stored at source A 240, source B 230, and source C 250 in respective memories 244, 234, 254, which may transmit media guidance data using processors 242, 232, and 252, respectively. Specifically, processors 232, 242, 252, as well as processors 204 and 262 may receive and process requests for media guidance data for one or more media assets from core data server 202 or any other source or device accessible via communications network 220. A core data server 202, upon which a media guidance application may be implemented, may function as a stand-alone device or may be part of a network of devices. Various network configurations of devices may be implemented and are discussed in more detail below.

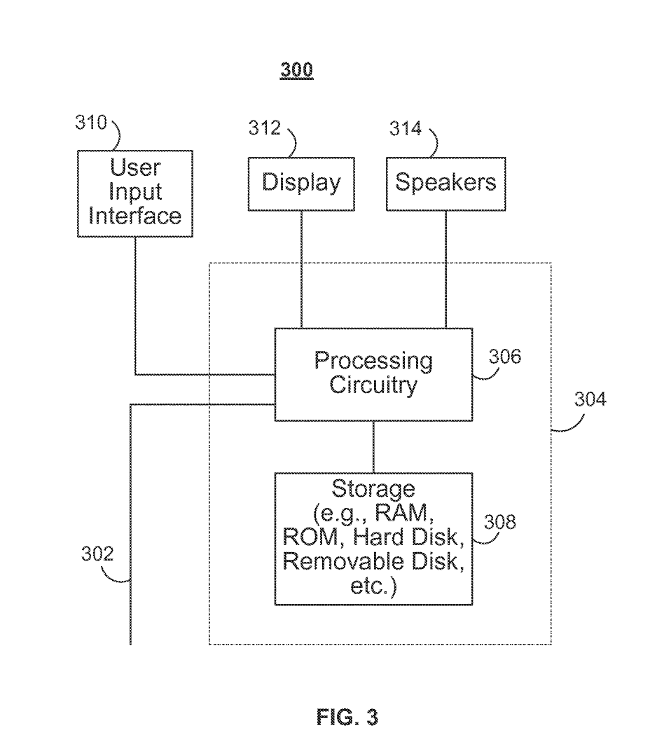

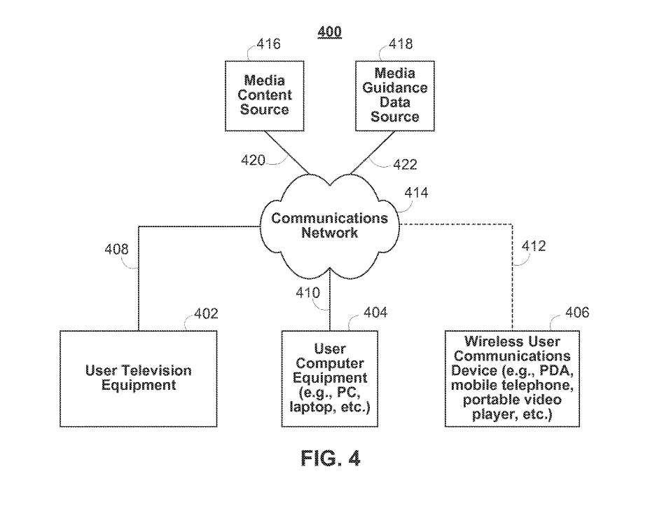

Source A 240, source B 230, and source C 250 may include at least some of the device components features described below in connection with FIG. 3 and/or may be networked as described in relation to FIG. 4. The sources may or may not be stand-alone devices or devices of the same type. For example, source A may be Internet-enabled, allowing for access to Internet content, while source B may include a tuner allowing for access to television programming. Source C may be a remote database or other type of storage device. Furthermore, core data 202, source A 240, source B 230, and source C 250 may represent devices that are used to perform operations related to the functions of core data 202, source A 240, source B 230, source C 250, and requester 260, respectively. For example, source A 240 may represent a website on which media guidance data is accessible. Source A includes a processor 242 and a memory 244. Likewise, source B 230 could be a tablet computer or a remote storage device, including cloud storage as explained above. Finally, source C 250 could be a set-top box, headend device, or a central server used in operation with the set-top box.

The source equipment may be coupled to communications network 220. Namely, source A 240, source B 230, and source C 250 are coupled to communications network 220 via communications paths 226, 228, and 224, respectively. Communications network 220 may be one or more networks including the Internet, a mobile phone network, mobile voice or data network (e.g., a 4G or LTE network), cable network, public switched telephone network, or other types of communications network or combinations of communications networks. Paths 226, 228, and 224 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the source equipment may be provided by one or more of these communications paths, but are shown as a single path in FIG. 2 to avoid overcomplicating the drawing.

Although communications paths are not drawn among the source equipment, these devices may communicate directly with each other via communication paths, such as those described above in connection with paths 226, 228, and 224, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The requester 260 and core data server 202 may also communicate with each other, or the source equipment, directly through an indirect path via communications network 220.

System 200 also includes core data server 202 coupled to communications network 220 via communication path 222. Path 222 may include any of the communication paths described above in connection with communication paths 226, 228, and 224. Communications with the core data server 202 and source A 240, source B 230 and source C 250 may be exchanged over one or more communications paths, but are shown as a single path in FIG. 2 to avoid overcomplicating the drawing. In addition, there may be more than one core data server 202, but only one is shown in FIG. 2 to avoid overcomplicating the drawing.

If desired, core data server 202, source A 240, source B 230 and source C 250 may be integrated as one device. Although the connection of core data server 202, source A 240, source B 230, and source C 250 are shown through communications network 220, in some embodiments, core data server 202 may communicate directly with source A 240, source B 230 and source C 250 via other communication paths (not shown).

Source A 240, source B 230 and/or source C 250 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Source A 240, source B 230 and/or source C 250 may be the originator of content (e.g., a television broadcaster, a Webcast provider, etc.) or may not be the originator of content (e.g., an on-demand content provider, an Internet provider of content of broadcast programs for downloading, etc.). Source A 240, source B 230 and/or source C 250 may include cable sources, satellite providers, on-demand providers, Internet providers, over-the-top content providers, or other providers of content. Source A 240, source B 230 and/or source C 250 may also include a remote media server used to store different types of content (including video content selected by a user), in a location remote from any of the source equipment. Systems and methods for remote storage of content, and providing remotely stored content to source equipment are discussed in greater detail in connection with Ellis et al., U.S. Pat. No. 7,761,892, issued Jul. 20, 2010, which is hereby incorporated by reference herein in its entirety.

Core data server 202 may extract, from media guidance data, user profiles. A user profile, or media content interests, may be received by the requester using any suitable approach. In some embodiments, core data server 202 may be a stand-alone server that receives media content interests from source A, source B, and source C via a data feed (e.g., a continuous feed or trickle feed).

Core data server 202 may include numerous components for receiving, extracting, normalizing, and/or comparing data as well as populating a database. Processor 204 may be used to issue, receive, and process requests from sources accessible via communications network 220. Furthermore, processor 204 may incorporate numerous modules (e.g., receiving module 206, extracting module 208, comparing module 210, normalizing module 212, generation module 214, reliability module 216 and output module 218) for performing various functions, which are shown separately for clarity, but which may be implemented using one or more processors or other control circuitry, or which may be implemented as software executable by one or more processors. Processor 204 may also store the media guidance data retrieved from various sources (e.g., source A 240, source B 230, and/or source C 250).

Receiving module 206 may be configured to receive and query sources accessible via communications network 220 for media guidance data. Extracting module 208 may be configured to extract data, including a plurality of fields from a source (e.g., source A 240). Comparing module 210 may compare the data from one source to data stored at memory 216. Normalizing module 212 may be configured to normalize extracted data before the data is processed by comparing module 210. Memory 216 may be configured to store media guidance data, individual field scores, threshold field scores, composite scores, threshold composite scores, and/or any other data about media assets and/or media guidance data. Output module 218 may be configured to output prompts (e.g., onto user interface 102 (FIG. 1)) related to media guidance data that is determined to correspond to a particular media asset.

In addition, core data server 202, source A 240, source B 230, and source C 250 as well as any media guidance data may include data structures (e.g., ordered/unordered flat files, hash tables, B+ trees, ISAM, and/or heaps). The media guidance application implemented on core data server 202 may interpret and normalize such structures via normalizing module 212. In addition, core data server 202, source A 240, source B 230, and source C 250 may use any database management system and any standard encoding (e.g., ASCII, JPEG, MPEG-4).

In some embodiments, core data server 202 may receive information from the source equipment using a client-server approach. For example, core data server 202 may pull media guidance data and source information from the source equipment. In some embodiments, core data server 202 may initiate sessions when the media guidance data or source information is out of date or when core data server 202 receives a request from the requester 260. Media guidance data and source information may be provided to core data server 202 with any suitable frequency (e.g., continuously, daily, a system-specified period of time, in response to a request). In addition, the media guidance application may provide itself, or source equipment, with software updates and may implement the processes of this disclosure as software or a set of executable instructions which may be stored in storage 308, and executed by control circuitry 304 of device 300 of FIG. 3, or any other device shown in FIGS. 1-4.

Media guidance data or source information may be delivered to core data server 202 as over-the-top (OTT) content and the source of the media guidance data may be OTT providers. OTT content delivery allows Internet-enabled devices, including set-top box source equipment as described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide user profiles, media content interests, source information, or media guidance delivered as described above.

Network system 200 is intended to illustrate a number of approaches, or network configurations. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, which provide cloud-based services to various types of users and devices connected via a network such as the Internet via communications network 220. These cloud resources may include one or more user profiles, media content interests or source information used by core data server 202, source A 240, source B 230, or source C 250. In addition, core data server 202 may be implemented in the cloud.

The cloud provides access to services, such as content storage, content sharing, or social networking services, among other examples, as well as access to any content described above, for devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow source equipment or core data server 202 to store content to the cloud and to receive content from the cloud rather than storing content locally and accessing locally stored content.

Cloud resources may be accessed by source equipment, for example, a web browser, a media guidance application, a desktop application, a mobile application, and/or any combination of access applications of the same. The source equipment may be a cloud client that relies on cloud computing for application delivery, or the source equipment may have some functionality without access to cloud resources. For example, some applications running on the source equipment may be cloud applications, i.e., applications delivered as a service over the Internet, while other applications may be stored and run on the source equipment. In some embodiments, source equipment or core data server 202 may receive content from multiple cloud resources simultaneously. In some embodiments, user equipment devices can use cloud resources for processing operations such as the processing operations performed by processing circuitry described in relation to FIG. 3.

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 312 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for performing the functions described herein. For simplicity, these devices may be referred to herein collectively as user equipment or user equipment devices, and may be substantially similar to user equipment devices described above. User equipment devices, on which a media guidance application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a website accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings (e.g., preferred media guidance data providers, schedules for receiving media guidance data, formats for media guidance data, etc.) across local devices and remote devices.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

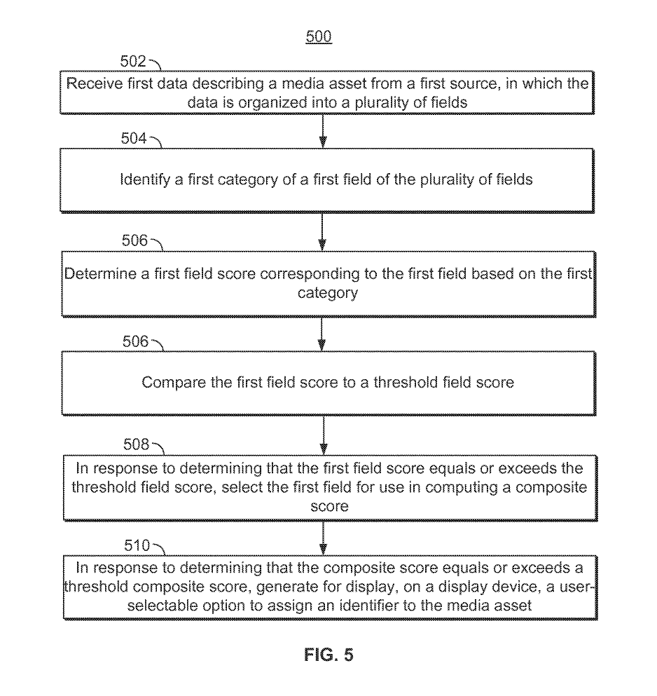

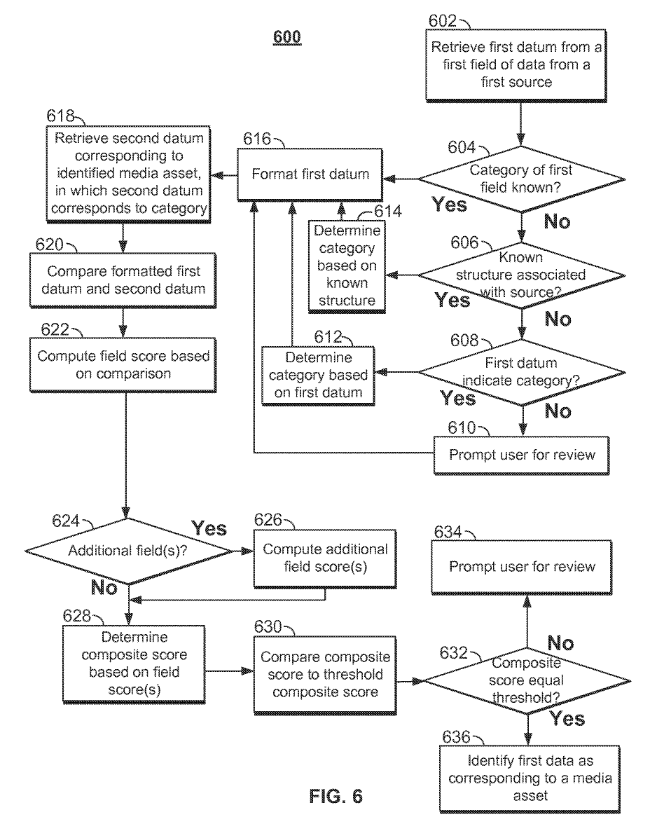

FIG. 5 shows a flowchart of illustrative steps for generating for display, on a display device, a user-selectable option to assign an identifier to the media asset. It should be noted that process 500 or any step thereof could be performed on, or provided by, any of the devices shown in FIGS. 1-4. For example, process 500 may be executed by control circuitry 304 (FIG. 3) as instructed by a media guidance application implemented on user equipment 402, 404, and/or 406 (FIG. 4) in order to generate for display, on a display device, a user-selectable option to assign an identifier to the media asset. In addition, one or more steps of process 500 may be incorporated into or combined with one or more steps of any other process or embodiment (e.g., process 600 (FIG. 6)).

At step 502, the media guidance application extracts (e.g., via control circuitry 304 (FIG. 3)) first data describing a media asset from a first source, in which the data is organized into a plurality of fields. For example, each field of the plurality of fields may correspond to a particular category of media guidance data (e.g., title, genre, release date, etc.). During process 600 (or prior to or after), the media guidance application may store the first data in a storage device (e.g., storage 308 (FIG. 3) and/or any location accessible via communications network 414 (FIG. 4)).

At step 504, the media guidance application identifies (e.g., via control circuitry 304 (FIG. 3)) a first category of a first field of the plurality of fields. For example, the media guidance application may process (e.g., via control circuitry 304 (FIG. 3)) data (e.g., stored at storage 308 (FIG. 3) and/or any location accessible via communications network 414 (FIG. 4)) corresponding to the first field according to the identified category. For example, the media guidance application may determine (e.g., via control circuitry 304 (FIG. 3)) a first data type (e.g., an alphanumeric dating system) of the first field. The media guidance application may then cross-reference (e.g., via control circuitry 304 (FIG. 3)) the first data type with a database (e.g., located at storage 308 (FIG. 3) and/or any location accessible via communications network 414 (FIG. 4)) listing categories that correspond to various data types to determine the first category. For example, in response to determining that an alphanumeric dating system found in the first field typically indicates a release date, the media guidance application may determine (e.g., via control circuitry 304 (FIG. 3)) that the first field corresponds to a release date of the media asset.

At step 506, the media guidance application determines (e.g., via control circuitry 304 (FIG. 3)) a first field score corresponding to the first field based on the first category. For example, the media guidance application may compare the release date for the media asset as indicated by the first field (e.g., a first datum) to a known release date for the media asset (e.g., a second datum from a second source) to determine a level of similarity between the two release dates. Based on the level of similarity, the media guidance application may assign a score (e.g., stored at storage 308 (FIG. 3) and/or any location accessible via communications network 414 (FIG. 4)) to the first field. For example, if the release dates are identical the score is likely higher than if the release dates are different. Additionally, the media guidance application may determine a boost metric (e.g., from a database located at storage 308 (FIG. 3) and/or any location accessible via communications network 414 (FIG. 4)) that indicates an importance or reliability of the first category associated with the first category, which the media guidance application may cross-reference with a database listing weights associated with various boost metrics to determine a weight to apply to the first field when computing a composite score. For example, the media guidance application may apply a higher boost metric to one category (e.g., title), which typically has a higher level of similarity, than another category (e.g., summary information), which typically has a lower level of similarity.

At step 508, the media guidance application compares (e.g., via control circuitry 304 (FIG. 3)) the first field score to a threshold field score (e.g., retrieved from storage 308 (FIG. 3) and/or any location accessible via communications network 414 (FIG. 4)). For example, the media guidance application may determine (e.g., via control circuitry 304 (FIG. 3)) whether or not the first field score is sufficient enough for use based on a comparison to the threshold field score. If so, the media guidance application selects (e.g., via control circuitry 304 (FIG. 3)) the first field for use in computing a composite score at step 508. For example, the composite score (e.g., complied and stored at storage 308 (FIG. 3) and/or any location accessible via communications network 414 (FIG. 4)) may indicate a level of similarity between the first data and second data, in which the second data is from a second source and corresponds to data known about the media asset. If not, the media guidance application may prompt a user to manually review the first field score (e.g., via display 312 (FIG. 3)).

The media guidance application determines (e.g., via control circuitry 304 (FIG. 3)) whether or not the composite score equals or exceeds a threshold composite score (e.g., retrieved from storage 308 (FIG. 3) and/or any location accessible via communications network 414 (FIG. 4)). If so, the media guidance application generates for display (e.g., via control circuitry 304 (FIG. 3)), on a display device (e.g., via display 312 (FIG. 3)), a user-selectable option to assign an identifier to the media asset at step 510. For example, in response to determining that the first data has a threshold level of similarity with data known to correspond to a particular media asset, the media guidance application may prompt (e.g., via control circuitry 304 (FIG. 3)) a user to verify that the first data corresponds to the particular media asset. Additionally, the media guidance application may prompt (e.g., via control circuitry 304 (FIG. 3)) a user to determine whether to aggregate the first data and the second data in a database. For example, in response to determining that the first data corresponds to a particular media asset, the media guidance application may incorporate the first data into a database (e.g., located at storage 308 (FIG. 3) and/or any location accessible via communications network 414 (FIG. 4)) listing known data about the media asset.

In some embodiments, the composite score (e.g., retrieved from storage 308 (FIG. 3) and/or any location accessible via communications network 414 (FIG. 4)) may include respective field scores for each field of a plurality of fields. For example, the media guidance application may identify (e.g., via control circuitry 304 (FIG. 3)) categories and field scores based on the identified categories for one or more fields of the plurality of fields in the first data. For example, the media guidance application may compare each field (e.g., corresponding to a particular category) of the data set to a field (e.g., corresponding to the same category) of the data known to correspond to a particular media asset to determine how similar received data is to data known to correspond to a particular media asset. Moreover, the order in which each field is compared may depend on the fields that were already compared. For example, the media guidance application may increase (e.g., via control circuitry 304 (FIG. 3)) the efficiency of the comparison process by dynamically selecting which categories to compare (e.g., the media guidance application may compare more important and/or reliable categories before less important and/or reliable categories).

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 1-4 could be used to perform one or more of the steps in FIG. 5.

FIG. 6 shows a flowchart of illustrative steps involved in updating a source of media guidance data. It should be noted that process 500 or any step thereof could be performed on, or provided by, any of the devices shown in FIGS. 1-4. For example, process 500 may be executed by control circuitry 304 (FIG. 3) as instructed by a media guidance application implemented on user equipment 402, 404, and/or 406 (FIG. 4) in order to update a source of media guidance data. In addition, one or more steps of process 500 may be incorporated into or combined with one or more steps of any other process or embodiment (e.g., process 600 (FIG. 6)).

At step 602, the media guidance application retrieves (e.g., via control circuitry 304 (FIG. 3)) a first datum from a first field from a first source (e.g., located at any source accessible via communications network 220 (FIG. 2)). The first datum may describe a media asset that the media guidance application is attempting (e.g., via control circuitry 304 (FIG. 3)) to identify. For example, the media guidance application may receive media guidance data from multiple sources (e.g., source A 240 (FIG. 2)). The media guidance data may be structured in a plurality of fields in which each field corresponds to a particular category. Furthermore, each field may include a datum indicating a characteristic of the media asset in the respective category. For example, if the field is a title field, the first datum may indicate the title of the media asset. If the field is a genre field, the first datum may indicate the genre of the media asset.

At step 604, the media guidance application determines (e.g., via control circuitry 304 (FIG. 3)) whether or not the category of the first field is known. For example, the media guidance application may receive (e.g., via control circuitry 304 (FIG. 3)) data from multiple sources. In some cases, the received data may be tagged to indicate a category associated with each field of a plurality of fields. For example, the tag may indicate the field of a plurality of fields that corresponds to a particular category. For example, in response to receiving data from a source, the media guidance application may determine (e.g., via control circuitry 304 (FIG. 3)) the tag associated with each field. However, in some cases, the media guidance application may not detect tags for the fields of the received data. If the media guidance application determines (e.g., via control circuitry 304 (FIG. 3)) that the category of the first field is known, the media guidance application proceeds to step 616. If the media guidance application determines that the category of the first field is unknown, the media guidance application proceeds to step 606.

At step 606, the media guidance application determines (e.g., via control circuitry 304 (FIG. 3)) whether or not there is a known structure associated with the source. For example, the media guidance application may receive data from multiple sources. In some cases, the media guidance application may also have a mapping of the structure of the received data. For example, the map may indicate the field of a plurality of fields that corresponds to a particular category. For example, in response to receiving data from a source, the media guidance application may retrieve (e.g., via control circuitry 304 (FIG. 3)) the mapping associated with that source. In some cases, the media guidance application may not have a mapping of the structure of the received data. For example, the source may be a new source to the media guidance application and/or the source may not have a consistent structure. If the media guidance application determines that the category of the first field is known, the media guidance application proceeds to step 614. At step 614, the media guidance application determines (e.g., via control circuitry 304 (FIG. 3)) the category based on the known structure before proceeding to step 616. For example, the media guidance application may cross-reference (e.g., via control circuitry 304 (FIG. 3)) the category with a database (e.g., located at storage 308 (FIG. 3) and/or any location accessible via communications network 414 (FIG. 4)) listing the mapping of the structure to determine which field corresponds to the category. If the media guidance application determines that the structure associated with the source is unknown, the media guidance application proceeds to step 608.

At step 608, the media guidance application determines (e.g., via control circuitry 304 (FIG. 3)) whether or not the first datum indicates the category. For example, the media guidance application may determine whether or not the first datum includes triggers or other indicia of a particular category. For example, the media guidance application may cross-reference (e.g., via control circuitry 304 (FIG. 3)) the first datum in a database (e.g., located at storage 308 (FIG. 3) and/or any location accessible via communications network 414 (FIG. 4)) listing industry standard naming conventions, serial number formats, etc., to determine whether or not the first datum corresponds to a particular naming convention, serial number format, etc. (e.g., associated with a particular category). If the media guidance application determines (e.g., via control circuitry 304 (FIG. 3)) that the first datum indicates the category (e.g., the first datum corresponds to an industry standard for a title format), the media guidance application determines (e.g., via control circuitry 304 (FIG. 3)) that category based on the first datum at step 612 before proceeding to step 616. If the media guidance application determines (e.g., via control circuitry 304 (FIG. 3)) that the first datum does not indicate the category (e.g., the first datum does not correspond to any industry standard for any category), the media guidance application proceeds to step 610 and prompts (e.g., via control circuitry 304 (FIG. 3)) a user for review. For example, the media guidance application may generate for display (e.g., on display 312 (FIG. 3)) a prompt that queries the user to identify a category. In some embodiments, the media guidance application may provide (e.g., on user interface 102 (FIG. 1)) the user a list of suggested categories. After receiving a user selection of the category, the media guidance application proceeds to step 616.

At step 616, the media guidance application formats (e.g., via control circuitry 304 (FIG. 3)) the first datum. For example, the media guidance application may normalize received data before comparing data in order to improve the results of the comparison. For example, based on the category, the media guidance application may convert (e.g., via control circuitry 304 (FIG. 3)) the first datum from a current format to the format associated with its respective category (if different from the current format). For example, the media guidance application (e.g., via normalization module 212 (FIG. 2)) may convert the current format of the first datum to a format that corresponds to second data (e.g., as stored at a second source such as core data server 202 (FIG. 2)). For example, the media guidance application may cross-reference the determined category with a database (e.g., located at storage 308 (FIG. 3) and/or any location accessible via communications network 414 (FIG. 4)) listing preferred formats for that category. For example, the preferred format may correspond to the format of data in the category in a second source (e.g., memory 216 (FIG. 2)).

At step 618, the media guidance application retrieves (e.g., via control circuitry 304 (FIG. 3)) a second datum, corresponding to an identified media asset, from a second source (e.g., core data server 202 (FIG. 2) and/or any location accessible via communications network 414 (FIG. 4)), in which the second datum corresponds to the determined category. For example, the media guidance application may compare (e.g., via control circuitry 304 (FIG. 3)) the first datum to a second datum that corresponds to the same category (e.g., title), in which the second datum is known to correspond to a particular media asset. By comparing the received data to data of an identified media asset, the media guidance application may determine (e.g., via control circuitry 304 (FIG. 3)) whether or not the received data corresponds (or does not correspond) to the identified media asset.

At step 620, the media guidance application compares (e.g., via control circuitry 304 (FIG. 3)) the formatted first datum and the second datum and computes a field score based on the comparison at step 622. For example, as discussed above in relation to step 506 (FIG. 5), the media guidance application may determine (e.g., via control circuitry 304 (FIG. 3)) a first field score based on the level of similarity between the first datum and the second datum. For example, the media guidance application may compare (e.g., via control circuitry 304 (FIG. 3)) the title for the media asset as indicated by the first field (e.g., a first datum) to a known title for a media asset (e.g., a second datum from a second source) to determine a level of similarity between the titles. Based on the level of similarity, the media guidance application may assign (e.g., via control circuitry 304 (FIG. 3)) a field score (e.g., stored at storage 308 (FIG. 3) and/or any location accessible via communications network 414 (FIG. 4)) to the first field.

At step 624, the media guidance application determines (e.g., via control circuitry 304 (FIG. 3)) whether or not there are any additional fields. For example, the media guidance application may identify (e.g., via control circuitry 304 (FIG. 3)) a plurality of fields in media guidance data received from a source. The media guidance application may process each field (e.g., compare a datum in a respective field to corresponding fields of a second source) to determine the similarity between the data in each field. If the media guidance application determines (e.g., via control circuitry 304 (FIG. 3)) that there are additional fields, the media guidance application computes additional field scores. For example, the media guidance application may repeat one or more of the steps of process 600 with respect to a different field before proceeding to step 628. If the media guidance application determines that there are no additional fields, the media guidance application proceeds directly to step 628.

At step 628, the media guidance application determines (e.g., via control circuitry 304 (FIG. 3)) a composite score based on the one or more field scores. For example, based on the results of one or more field scores (e.g., indicating the level of similarity between data about a media asset received from a first source and data about an identified media asset from a second source), the media guidance application may determine (e.g., via control circuitry 304 (FIG. 3)) a likelihood that the data received from the first source and the data from the second source relate to the same media asset.

At step 630, the media guidance application compares (e.g., via control circuitry 304 (FIG. 3)) the composite score to a threshold composite score (e.g., retrieved from storage 308 (FIG. 3) and/or any location accessible via communications network 414 (FIG. 4)). For example, the media guidance application may retrieve a threshold composite score, which indicates a minimum amount of similarity between data from the two sources that is required to indicate that the data relates to the same media asset.

At step 632, the media guidance application determines (e.g., via control circuitry 304 (FIG. 3)) whether or not the composite score equals or exceeds a threshold composite score (e.g., retrieved from storage 308 (FIG. 3) and/or any location accessible via communications network 414 (FIG. 4)). If the media guidance application determines (e.g., via control circuitry 304 (FIG. 3)) that the composite score does not equal or exceed the threshold composite score, the media guidance application generates for display (e.g., via control circuitry 304 (FIG. 3)), on a display device (e.g., via display 312 (FIG. 3)), a prompt for a user to review at step 634. For example, in response to determining that the first data does not have a threshold level of similarity with data known to correspond to a particular media asset, the media guidance application may prompt (e.g., via control circuitry 304 (FIG. 3)) a user to verify the discrepancy. In some embodiments, the media guidance application may provide suggestions for media assets to which the received data corresponds. The suggestions may include the media asset that corresponds to the data that the media guidance application compared against the received data as well as other media assets.

If the media guidance application determines (e.g., via control circuitry 304 (FIG. 3)) that the composite score does equal or exceed the threshold composite score, the media guidance application identifies (e.g., via control circuitry 304 (FIG. 3)) the first data as corresponding to a media asset. Additionally, the media guidance application may prompt (e.g., via control circuitry 304 (FIG. 3)) a user to determine whether to aggregate the first data and the second data in a database (e.g., core data server 202 (FIG. 2)). For example, in response to determining that the first data corresponds to a particular media asset, the media guidance application may incorporate (e.g., via control circuitry 304 (FIG. 3)) the first data into a database (e.g., located at storage 308 (FIG. 3) and/or any location accessible via communications network 414 (FIG. 4)) listing known data about the media asset.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 1-4 could be used to perform one or more of the steps in FIG. 6.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for identifying media assets, the method comprising:
extracting first data describing a media asset from a first source, wherein the data is organized into a plurality of fields;
identifying a first category of a first field of the plurality of fields;
determining a first field score corresponding to the first field based on the first category;
comparing the first field score to a threshold field score; and
in response to determining that the first field score equals or exceeds the threshold field score, selecting the first field for use in computing a composite score;
in response to determining that the composite score equals or exceeds a threshold composite score, generating for display, on a display device, a user-selectable option to assign an identifier to the media asset.

2. The method of claim 1, wherein the composite score indicates a level of similarity between the first data and second data, and wherein the second data is from a second source and corresponds to data known about the media asset.

3. The method of claim 2, further comprising aggregating the first data and the second data in a database in response to determining that the composite score equals or exceeds the threshold composite score.

4. The method of claim 1, further comprising:
determining a boost metric associated with the first category, wherein the boost metric indicates an importance or reliability of the first category; and
cross-referencing the boost metric with a database listing weights associated with various boost metrics to determine a weight to apply to the first field when computing a composite score.

5. The method of claim 4, wherein determining the boost metric further comprises cross-referencing the first source with a database listing boost metrics associated with various sources to determine the boost metric.

6. The method of claim 2, wherein determining the first field score corresponding to the first field based on the first category further comprises:
determining a first datum of the first data corresponding to the first field;
determining a second field of the second data that corresponds to the first category;
determining a second datum of the second field; and
comparing the first datum to the second datum to determine the first field score corresponding to the first field.

7. The method of claim 1, further comprising in response to determining that the composite score equals or exceeds a threshold composite score, prompting a user to determine whether to aggregate the first data and the second data in a database.

8. The method of claim 1, further comprising in response to determining that the first field score does not equal or exceed the threshold field score, prompting a user to review the first field score.

9. The method of claim 1, wherein an order in which a respective field score for each field of the plurality of fields is determined is updated after each respective field score is determined.

10. The method of claim 1, wherein identifying the first category of the first field of the plurality of fields comprises:
determining a first data type of the first field; and
cross-referencing the first data type with a database listing categories that correspond to various data types to determine the first category.

11. A system for identifying media assets, the system comprising:
storage circuitry configured to store a threshold field score; and
control circuitry configured to:
extract first data describing a media asset from a first source, wherein the data is organized into a plurality of fields;
identify a first category of a first field of the plurality of fields;
determine a first field score corresponding to the first field based on the first category;
compare the first field score to a threshold field score; and
in response to determining that the first field score equals or exceeds the threshold field score, select the first field for use in computing a composite score; and
in response to determining that the composite score equals or exceeds a threshold composite score, generate for display, on a display device, a user-selectable option to assign an identifier to the media asset.

12. The system of claim 11, wherein the composite score indicates a level of similarity between the first data and second data, and wherein the second data is from a second source and corresponds to data known about the media asset.

13. The system of claim 12, wherein the control circuitry is further configured to aggregate the first data and the second data in a database in response to determining that the composite score equals or exceeds the threshold composite score.

14. The system of claim 11, wherein the control circuitry is further configured to:
determine a boost metric associated with the first category, wherein the boost metric indicates an importance or reliability of the first category; and
cross-reference the boost metric with a database listing weights associated with various boost metrics to determine a weight to apply to the first field when computing a composite score.

15. The system of claim 14, wherein the control circuitry is further configured to determine the boost metric further comprises cross-referencing the first source with a database listing boost metrics associated with various sources to determine the boost metric.

16. The system of claim 12, wherein the control circuitry configured to determine the first field score corresponding to the first field based on the first category is further configured to:
determine a first datum of the first data corresponding to the first field;
determine a second field of the second data that corresponds to the first category;
determine a second datum of the second field; and
compare the first datum to the second datum to determine the first field score corresponding to the first field.

17. The system of claim 11, wherein the control circuitry is further configured to prompt a user to determine whether to aggregate the first data and the second data in a database in response to determining that the composite score equals or exceeds a threshold composite score.

18. The system of claim 11, wherein the control circuitry is further configured to prompt a user to review the first field score in response to determining that the first field score does not equal or exceed the threshold field score.

19. The system of claim 11, wherein an order in which a respective field score for each field of the plurality of fields is determined is updated after each respective field score is determined.

20. The system of claim 11, wherein the control circuitry configured to identify the first category of the first field of the plurality of fields is further configured to:
determine a first data type of the first field; and
cross-reference the first data type with a database listing categories that correspond to various data types to determine the first category.

21-50. (canceled)
